(19) United States
(12) Patent Application Publication
(10) Pub. No.: US 2001/0046115 A1
(43) Pub. Date: Nov. 29, 2001

(54) Computer monitor add-on memo board

(76) Inventor: William Genicevitch, Santa Ana, CA (US)

Correspondence Address: MORLAND C FISCHER, 2030 MAIN ST, SUITE 1050, IRVINE, CA, 92614

(21) Appl. No.: 09/835,226

(22) Filed: Apr. 13, 2001

Related U.S. Application Data
(60) Provisional application No. 60/199,684, filed on Apr. 21, 2000.

(51) Int. Cl. G06F 1/16

(52) U.S. Cl. 361/682; 361/681

(57) ABSTRACT

An add-on memo board to be attached to the front of a video (e.g., computer) monitor to surround the screen thereof. The add-on memo board has a writing surface (e.g., a white board) that enables the computer user to have a convenient and readily accessible place to write messages without resorting to paper tablets and stick-on note pads. Different headings are inscribed on the writing surface to enable the user to organize and group his messages according to subject. The memo board is removably attached to the monitor by pieces of two-sided tape disposed therebetween. A writing instrument holder projects outwardly at the front of the memo board in which to receive and hold a writing instrument (e.g., a felt tip marker) of the type that is suitable for writing messages on the writing surface.

### CROSS-REFERENCE TO RELATED APPLICATIONS

This patent application is a continuation of Provisional patent application No. 60/199,684 filed Apr. 21, 2000.

### BACKGROUND OF THE INVENTION

1. Field of the Invention

This invention relates to an add-on memo board to be adhesively attached to the front face of a video (e.g., computer) monitor The add-on memo board has a reusable writing surface with different headings permanently marked thereon so that the user can write and group messages according to their subject at easy to find, predetermined locations.

2. Background Art

Whether at home or in business, computer users are bombarded with numerous bits of information that are useful to the operation and enjoyment of a computer. For example, it may be necessary to keep a written record of different web addresses, telephone numbers, key strokes, or simply a list of things to do In some cases, the computer user will record this information on a paper tablet. In this case, the user must first have access to a tablet on which to write the information. Then, the user must be able to locate the tablet at those times in the future when he wishes to retrieve the information. However, such tablets are often misplaced or hard to find, particularly at a crowded work area. In other cases, the user will record information on adhesive-backed notepads. In this case, small pieces of note paper are stuck to the front of the computer monitor. Sticking many small pieces of paper around the front of the monitor creates a disorganized appearance and does not enable the user to quickly locate specific information of interest. Moreover, one or more of the small pieces of paper can fall off the monitor and become lost, thereby denying the user access to what may be important information.

What is needed is a more reliable, organized and convenient means for a computer user to save important written information so that the information is readily available without resorting to the usual tablets or stick-on notes and the problems inherent therewith.

### SUMMARY OF THE INVENTION

An add-on memo board is disclosed that is to be attached to the face of a video (e.g., computer) monitor. The memo board has an open rectangular window that is sized to surround the viewing screen of the monitor. The memo board also has a reusable writing surface (e.g., a white board) at the front thereof on which computer related and/or general messages can be written by the user. When the messages are no longer needed, they are simply erased and replaced by new messages. Headings are permanently inscribed on the writing surface so that the user can group different messages according to their subject at easy to find, predetermined locations. A writing instrument holder projects outwardly from the front of the add-on memo board to hold a writing instrument (e.g., a felt tip pen) at a readily accessible location to enable the user to write messages on the writing surface. Pieces of two-sided adhesive tapes are located at the back of the add-on memo board by which the memo board can be adhesively bonded to the front of the monitor. By virtue of using the add-on memo board to record messages, the usual paper tablets and stick-on adhesive notes may be advantageously avoided.

### BRIEF DESCRIPTION OF THE DRAWINGS

FIG. 1 shows the add-on memo board which forms my invention having a reusable writing surface on which messages can be written and grouped according to subject,

FIG. 2 is a side view of the add-on memo board of FIG. 1; and

FIG. 3 shows the add-on memo board adhesively attached to the face of a computer monitor so as to surround the viewing screen thereof.

### DETAILED DESCRIPTION

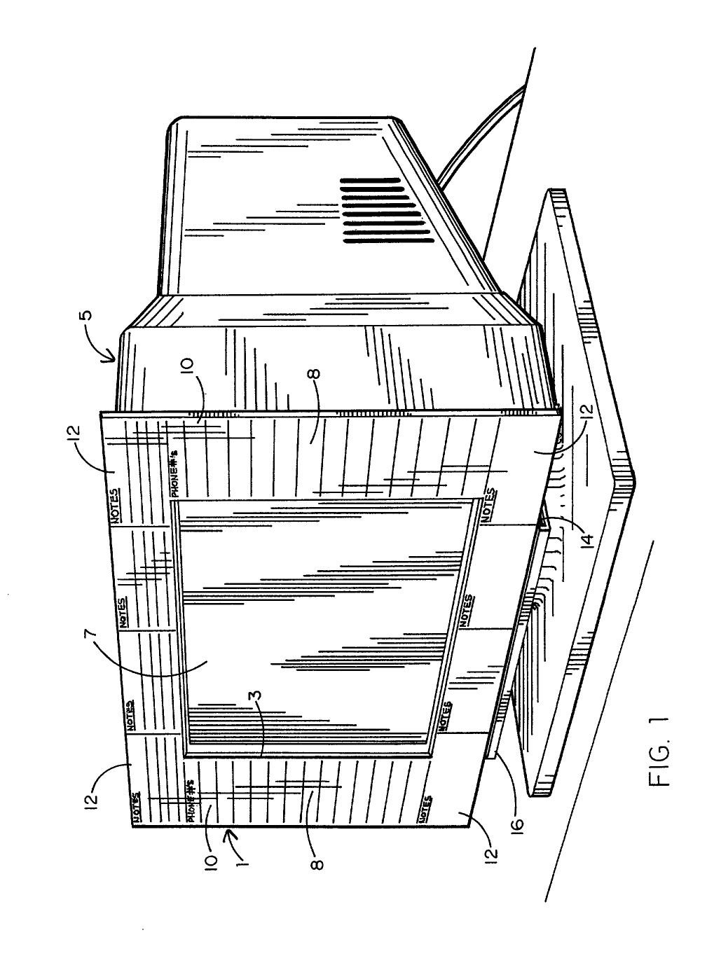

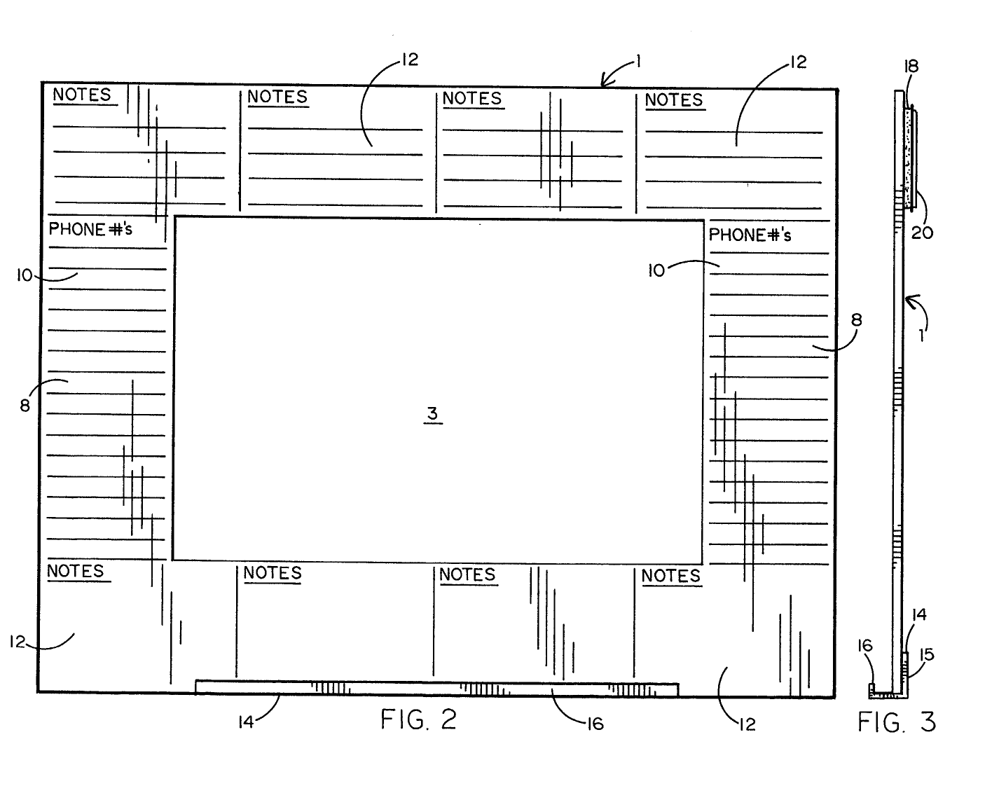

The computer monitor add-on memo board 1 which forms the present invention is described in detail while referring concurrently to FIGS. 1-3 of the drawings. Although my memo board 1 is capable of being used with any video monitor, for purposes of example, a computer monitor 5 will be described below As is best shown in FIGS. 1 and 2, my memo board 1 has a rectangular shape with a rectangular open window at the center thereof. The dimensions of memo board I will vary depending upon the size of the computer monitor to which it will be attached. Similarly, the size of the window 3 at the center of memo board 1 is also dependent upon the size of the screen 7 or viewing area of the monitor 5 so as not to obscure visual access thereto. Therefore, it may be appreciated that the add-on memo board 1 herein disclosed is capable of being attached to different computer monitors, and, therefore, memo boards like that shown in the drawings can be manufactured with different sizes to fit monitors of corresponding size.

The memo board 1 is manufactured from a relatively rigid material having a reusable writing surface 8 covering the front thereof. More particularly, the writing surface 8 of memo board 1 must be capable of receiving a message that is written by means of a conventional writing instrument, such as a pencil, crayon, chalk or a felt tip marker. By way of particular example, the writing surface 8 of memo board 1 is commonly known as a white board. Accordingly, a felt tip marker (not shown) will typically be used to write messages on writing surface 8. Once the message is no longer needed, it may be simply erased by using a rag, an eraser, a paper towel, or the like, to be replaced with a new message.

The message to be written on the writing surface 8 of add-on memo board 1 can be anything from a telephone number, a web or mailing address, the name of an individual or business, hard to remember key strokes, a things-to-do list, etc. To facilitate the user organizing and grouping his messages, especially when a large number of different messages are written on the writing surface 8 at the same time, the memo board 1 includes a variety of headings under which the user's messages are written. A set of lines is located below each heading,. For example the writing surface 8 of memo board 1 illustrated in FIG. 1 contains first designated areas 10 for writing, telephone numbers and other designated areas 12 for writing notes of general interest. However, it is to be understood that the identity and number of the headings that are inscribed on the writing surface 8 are not to be considered a limitation of this invention. In this same regard, different headings can be inscribed on different memo boards to meet the message needs of both business and home computer users. Therefore, the memo board 1 takes on the function of a template that surrounds the screen 7 of a computer monitor 5 within easy reach of the user.

The headings that are inscribed on the writing surface 8 should be of a permanent nature and not erased when the message is erased. Thus, the headings may be engraved or stamped into writing surface 8 or made by ink or other indelible markings. By listing different headings around the writing surface, the user will be advantageously provided with the convenience of having quick visual access to information that is necessary for the use and/or enjoyment of his computer without having to keep and locate space consuming and easy to misplace tear-off memo tables and stick-on memo pads. Moreover, since the add-on memo board 1 of my invention is reusable any number of times (i.e., by first erasing some or all of the original messages written thereon), the user will not have to be concerned with the frequent purchase and disposal of the usual paper tablets and note pads.

As is best shown in FIG. 3, a generally U-shaped (e.g., plastic) pen holder 14 has a first upturned lip 15 affixed (e.g., adhesively bonded) to the back of my add-on memo board 1. An opposing upturned lip 16 of pen holder 14 is spaced from the front of memo board 1 so as to run in parallel alignment along the bottom thereof. Pen holder 14 is of suitable length (e.g., ten inches) to receive and hold a writing, instrument (not shown) by which messages will be written on the writing surface 8 on the lines underneath the appropriate headings. In this way, the writing instrument will be conveniently stored adjacent to the computer monitor 5 so as to be readily accessible to the user at those times when its use is required.

The add-on memo board 1 is preferably attached to the front of computer monitor 5 by pieces of two-sided adhesive tape (designated 18 and best shown in FIG. 3). A first side of tape 18 is bonded to the back of the memo board 1, while the second side will be bonded to the front of computer monitor 5 so that the open window 3 of memo board 1 is positioned to surround the screen 7 of the monitor. The second side of the two-sided adhesive tape 18 is covered with a peel-off paper or wax liner 20 that is removed prior to attaching memo board 1 to

The size, number and location of the pieces of two-sided adhesive tape 18 at the back of memo board 1 will depend upon the size of the memo board. However, locating a three inch by five inch piece of tape 18 at each corner of the memo board 1 will be sufficient in most cases to firmly attach the board to the front of computer monitor 5. At the same time, by applying a suitable pulling force, the adhesive bond between the add-on memo board 1 and the computer monitor 5 can be broken should it become necessary to remove the memo board from the monitor.

By virtue of my add-on memo board, computer users will save time by not having to find a tablet or notepad on which to write computer-related messages. Moreover, notes will no longer have to be taped to the front of the monitor which has heretofore resulted in the haphazard storage of information, as well as a disorganized appearance. The computer user will become more organized and efficient, inasmuch as computer-related information can be grouped according to subject at immediately accessible and easy to find, pre-determined locations.

I claim:

1. An add-on memo board to be attached to the face of a computer monitor, said add-on memo board having a front, a back, an open window that is sized to surround the screen of the computer monitor, a writing surface at the front on which information is to be written, and a fastener by which to attach said memo board to the face of the computer monitor.

2. The add-on memo board recited in claim 1, wherein said writing surface is a white board, such that the information written thereon can be erased.

3. The add-on memo board recited in claim 1, including a set of headings printed on the writing surface at the front of said memo board, said headings designating particular areas of said memo board at which to group similar information.

4. The add-on memo board recited in claim 3, also including a plurality of parallel lines printed one under another below at least some of said headings on the writing surface of said memo board.

5. The add-on memo board recited in claim 4, wherein said set of headings and said plurality of parallel lines are permanently printed on said writing surface.

6. The add-on memo board recited in claim 1, including a holder for a writing instrument projecting outwardly from the front of said memo board within which to receive and hold a writing instrument.

7. The add-on memo board recited in claim 6, wherein said holder has a U-shape including a pair of upturned lips, a first of said pair of upturned lips connected to the back of said memo board, and the second of said pair of upturned lips spaced from said first upturned lip and projecting outwardly from the front of said memo board to hold the writing instrument.

8. The add-on memo board recited in claim 1, wherein said fastener to attach said memo board to the face of the computer monitor is at least one piece of two-sided adhesive tape, one side of said two-sided adhesive tape attached to the back of said memo board and the second side of said two-sided adhesive tape adapted to be adhesively bonded to the face of the computer monitor.

9. An add-on memo board to be attached to the face of a computer monitor, said add-on memo board comprising:
a back, a front and an open window that is sized to surround the screen of the computer monitor;
a reusable writing surface at the front on which information is to be written, said writing surface having headings printed thereon to designate the location at which similar information is to be grouped;
a writing instrument holder attached to the back and projecting outwardly from the front within which to receive and hold a writing instrument; and
an adhesive fastener carried at the back by which to adhesively bond said memo board to the face of the computer monitor;

10. The add-on memo board recited in claim 9, wherein said reusable writing surface is a white board.
